(19) United States
(12) Patent Application Publication
(10) Pub. No.: US 2016/0232539 A1
(43) Pub. Date: Aug. 11, 2016

(54) INFORMATION PROCESSING SYSTEM, INFORMATION PROCESSING METHOD, AND RECORDING MEDIUM WITH PROGRAM STORED THEREON

(71) Applicant: NEC CORPORATION, Tokyo (JP)

(72) Inventors: Satoshi MORINAGA, Tokyo (JP); Ryohei FUJIMAKI, Tokyo (JP)

(73) Assignee: NEC Corporation, Tokyo (JP)

(21) Appl. No.: 15/023,986

(22) PCT Filed: Sep. 3, 2014
(86) PCT No.: PCT/JP2014/004520

§ 371 Date: Mar. 22, 2016

Related U.S. Application Data
(60) Provisional application No. 61/883,660, filed on Sep. 27, 2013.

(51) Int. Cl. G06Q 30/02

(52) U.S. Cl. CPC G06Q 30/0201

(57) ABSTRACT

This invention helps improve the precision of data mining. This information processing device is provided with the following: a function-defining means that defines a new function by composing a plurality of functions; an attribute-generating means that applies said new function to an attribute to generate a new attribute that is the result of applying that function to that attribute; and a determining means that inputs the new attribute to an analysis engine, which executes an analysis process on the basis of the attribute, and determines whether or not information outputted by said analysis engine satisfies a prescribed requirement.

### TECHNICAL FIELD

The present invention relates to a technology of supporting data mining.

### BACKGROUND ART

Data mining is a technology of finding useful knowledge having been unknown so far from a large amount of information. As an actual example in which useful knowledge is obtained using data mining, an example in which sales data possessed by a major supermarket chain has been analyzed is known. As a result of analyzing the sales data, a knowledge that “a customer having purchased diapers tends to purchase beer at the same time” has been obtained. It is possible for the supermarket chain to make use of the knowledge to increase sales by taking measures such as measures “not to reduce prices of diapers and beer at the same time”.

A process of applying data mining to a specific example as described above can be roughly classified into three stages as described below.

A first stage (step) is a “pre-processing stage.” The “pre-processing stage” transforms, to cause a data mining algorism to efficiently function, by processing a feature to be input to a device or the like operating in accordance with the data mining algorism, the feature into a new feature.

A second stage is an “analysis processing stage.” The “analysis processing stage” inputs a feature to the device or the like operating in accordance with the data mining algorism, and obtains an analysis result that is an output of the device or the like operating in accordance with the data mining algorism.

A third stage is a “post-processing stage.” The “post-processing stage” converts the analysis result to an easily viewable graph, a control signal to be input to another device, or the like.

In this manner, to obtain useful knowledge using data mining, it is necessary to appropriately execute the “pre-processing stage.” A work of designing what procedures should be carried out as the “pre-processing stage” depends on knowledge of a skilled engineer (data scientist) in analysis technology. The design work of the pre-processing stage is not sufficiently supported by information processing technology and still depends to a large extent on trial and error through manual procedures by the skilled engineer.

NPL 1 discloses one example of software with which data mining is implemented. NPL 1 provides a function that supports a selection of a feature suitable for implementation of a desired task (analysis processing). This function is referred to also as a “feature selection.”

### CITATION LIST

### Non Patent Literature

[NPL 1] “WEKA”, [online], [retrieved on Sep. 5, 2013], the Internet <URL: http://www.cs.waikato.ac.nz/ml/weka/>

### SUMMARY OF INVENTION

### Technical Problem

Suppose that an operator performs data mining using the software disclosed by NPL 1. In this case, it is not always possible for the operator to obtain an accurate analysis result. The reason is that the software disclosed by NPL 1 merely selects a feature for obtaining an accurate analysis result among features prepared in advance. In this manner, there is a limitation, that is, the software disclosed by NPL 1 can only output a solution selected from the features prepared in advance. Therefore, when a feature by which an accurate analysis result is obtained is not included in the features prepared in advance, it is not possible for the operator to obtain an accurate analysis result.

One of the objects of the present invention is to provide an information processing system and the like contributing to accuracy improvement in analysis processing.

### Solution to Problem

A first aspect of the present invention is an information processing system including: function definition means for defining a new function by composing a plurality of functions; feature construction means for constructing, by applying the new function to a feature, a new feature that is a result obtained by applying a function to a feature; and test means for inputting the new feature to an analysis engine that executes analysis processing on a basis of the feature, and testing whether information output by the analysis engine satisfies a predetermined requirement.

A second aspect of the present invention is a control method including: controlling a computer accessible to function storage means storing a plurality of functions to: define a new function by composing the plurality of functions; construct, by applying the new function to a feature, a new feature that is a result obtained by applying a function to a feature; input the new feature to an analysis engine that executes analysis processing on a basis of the feature; and test whether information output by the analysis engine satisfies a predetermined requirement.

A third aspect of the present invention is a program that causes a computer accessible to function storage means storing a plurality of functions to execute: processing of defining a new function by composing the plurality of functions; processing of constructing, by applying the new function to a feature, a new feature that is a result obtained by applying a function to a feature; and processing of inputting the new feature to an analysis engine that executes analysis processing on a basis of the feature, and testing whether information output by the analysis engine satisfies a predetermined requirement.

An object of the present invention is achieved also with a computer-readable storage medium storing the program.

### Advantageous Effects of Invention

According to the present invention, it is possible to provide an information processing system and the like contributing to accuracy improvement in analysis processing.

### BRIEF DESCRIPTION OF DRAWINGS

FIG. 1 is a block diagram illustrating a configuration of an information processing system 1000 according to a first exemplary embodiment of the present invention.

FIG. 2 is a diagram illustrating one example of a data set according to the first exemplary embodiment of the present invention.

FIG. 3 is a diagram illustrating one example of data stored in a function storage unit 110 according to the first exemplary embodiment of the present invention.

FIG. 4 is a diagram illustrating an operation of a function definition unit 120 according to the first exemplary embodiment of the present invention.

FIG. 5 is a diagram illustrating details of a feature construction unit 130 according to the first exemplary embodiment of the present invention.

FIG. 6 is a diagram illustrating details of a test unit 140 according to the first exemplary embodiment of the present invention.

FIG. 7 is a diagram illustrating details of the test unit 140 according to the first exemplary embodiment of the present invention.

FIG. 8 is a diagram illustrating details of the test unit 140 according to the first exemplary embodiment of the present invention.

FIG. 9 is a flowchart illustrating an operation of the information processing system 1000 according to the first exemplary embodiment of the present invention.

FIG. 10 is a block diagram illustrating a configuration of an information processing system 1001 according to a second exemplary embodiment of the present invention.

FIG. 11 is a diagram illustrating one example of a data set according to the second exemplary embodiment of the present invention.

FIG. 12 is a diagram illustrating one example of data stored by a function storage unit 111 according to the second exemplary embodiment of the present invention.

FIG. 13 is a diagram illustrating details of a function definition unit 121 according to the second exemplary embodiment of the present invention.

FIG. 14 is a diagram illustrating details of a feature construction unit 131 according to the second exemplary embodiment of the present invention.

FIG. 15 is a diagram illustrating details of a test unit 141 according to the second exemplary embodiment of the present invention.

FIG. 16 is a block diagram illustrating a configuration of an information processing system 1002 according to a third exemplary embodiment of the present invention.

FIG. 17 is a diagram illustrating one example of a hardware configuration capable of implementing the information processing system according to each of the exemplary embodiments of the present invention.

### DESCRIPTION OF EMBODIMENTS

Initially, to be easily understood, wording used upon detailed description of an information processing system 1000 applicable with the present invention will be defined.

(Data Set)

A “data set” refers to data to be input to the information processing system 1000. The “data set” includes one feature or a plurality of features. The “feature” may be translated into a “variable.”

### Function

A “function” defines processing of constructing a new feature from a given feature. The “function” is applied to a feature included in a data set. In other words, when the “function” is applied to a feature, processing defined by the function is executed for the feature, and a new feature is constructed as a result.

In other words, the “function” defines an operation applied to a feature. This may be expressed in different words: the function defines processing of transforming a feature into another feature. The “function” may be a mapping applied to a feature included in a data set. In other words, a function indicates the above-described operation associated with the function. In other words, a function indicates the above-described processing associated with the function.

The processing defined by the “function” is, for example, a unary operation. The “function” defines an operation such as a trigonometric function (sin(X), cos(X), or tan(X)), a natural logarithm, an absolute value, sign inversion, or the like. The “function” may define an operation with a parameter n, such as, logₙ X, or Xⁿ.

The processing defined by the “function” is, for example, a polynomial operation. The polynomial operation is an operation having a plurality of operands. The “function” defines, for example, an arithmetic operation (addition, subtraction, multiplication, or the like) between a feature X and a feature Y. When the feature X and the feature Y are logical values, the “function” defines, for example, a logical operation (AND, OR, XOR, or the like) applied to a bit value of the feature X and a bit value of the feature Y.

The processing defined by the “function” may be “processing depending on data” in which processing is determined according to data. One specific example of the processing depending on data is normalization processing.

The “processing depending on data” is described below with a specific example. Suppose that, for example, a data set including information in which values of names and values of heights of 100 persons are correlated has been input to a data mining device. In this case, the data set includes two features including a feature that is “name” and a feature that is “height.” In this example, the feature that is “name” represents the values of the names of the 100 persons. The feature that is “value of height” represents the values of the heights of the 100 persons.

Suppose that the data mining device constructs, by applying a function that defines normalization processing to the feature “height”, a new feature that is “normalized height.” In this case, the data mining device does not individually normalize data for one person included in the feature. Suppose that the data mining device has initially received, for example, only a piece of information “name: N, height: 174” of a first person among pieces of information for the 100 persons. In this case, the data mining device does not calculate a new feature “normalized height” for the piece of information of the first person. The reason is that only when the data mining device completes the pieces of information of the 100 persons, values necessary for normalization as parameters (i.e. an average value of the values of “height” for the 100 persons and a standard deviation of “height” for the 100 persons) become available, and a function for normalization is fixed as a result.

For example, histogram construction, clustering, and Principal Component Analysis are exemplified as other specific examples of such “processing depending on data”.

(Composition of Functions) In the present application, sequentially applying processing defined by a first function and processing defined by a second function to a feature is described as a “composition of functions.” Suppose that, for example, the first function defines a function that is sin(X) and the second function defines a function that is X². When processing defined by the first function and processing defined by the second function are composed, a new function that is (sin(X))² or a new function that is sin(X²) is defined.

In this manner, when the first function and the second function are composed, a new third function is defined. Processing defined by the third function in this case is described below. When the processing defined by the third function is executed for a target feature, a new feature as described below is constructed. In other words, a new feature constructed when the processing defined by the first function and the processing defined by the second function are sequentially applied to the target feature is constructed by applying the third function.

(Analysis Engine)

An “analysis engine” is analysis processing based on a feature. In other words, the analysis engine receives a feature as an input, executes analysis on the basis of the feature, and outputs the result of analysis. The analysis engine is referred to also as an analysis algorism or the like executed by a data mining device. The analysis engine is an analysis engine that executes processing such as Regression Analysis, Factor Analysis, Covariance Structure Analysis, Principal Component Analysis (Principal Factor Analysis), Discriminant Analysis, Kernel Analysis, Heterogeneous Regression Analysis, Cluster Analysis, or Abnormality Detection. “Designation of a type of an analysis engine” represents reception of a designation of a type of such an analysis engine. The “analysis engine” may indicate, for example, a subject (e.g. a device) that executes the above-described analysis processing or a program that controls a processor to execute analysis processing.

(Constraint Condition)

A constraint condition is a requirement to be satisfied by information output by an analysis engine. In other words, the constraint condition is a requirement to be satisfied by an analysis result output by the analysis engine. When a type of the analysis engine is single regression analysis, one specific example of the constraint condition is that “a chi-square value is equal to or greater than 0.9.”

(Acquiring Information)

Hereinafter, reading out information from a storage device, receiving information from an external device, receiving an input of information from an operator, and the like is collectively described as “acquiring information.”

(Outputting Information)

Hereinafter, writing information to a storage device, transmitting information to an external device, presenting information to an operator in a form of screen display, a sound or the like, and the like is collectively described as “outputting information.”

By taking into consideration the above-described definitions of wording, exemplary embodiments of the present invention will be described in detail with reference to the drawings.

### First Exemplary Embodiment

A first exemplary embodiment is one specific example of the present invention in a case where single regression analysis is designated as a type of the analysis engine.

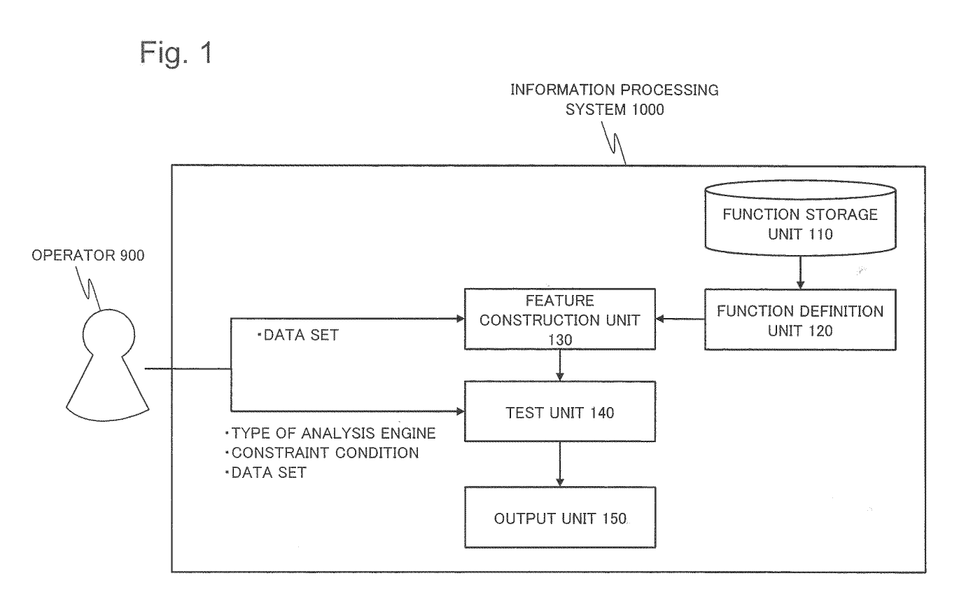

FIG. 1 is a block diagram illustrating an outline of an information processing system 1000 according to the first exemplary embodiment.

The information processing system 1000 includes a function storage unit 110, a function definition unit 120, a feature construction unit 130, a test unit 140, and an output unit 150.

The function storage unit 110 can store a plurality of functions. The function storage unit 110 may be implemented inside the information processing system 1000, or may be implemented in an external device, not illustrated, accessible by the information processing system 1000.

The function definition unit 120 acquires a plurality of functions from the function storage unit 110. The function definition unit 120 defines a new function by composing the acquired functions.

The feature construction unit 130 acquires a target data set. The feature construction unit 130 may receive an input of a data set from an operator, or may read out a data set from a storage unit, which is not illustrated. The feature construction unit 130 may receive a data set from a device, which is not illustrated, provided outside the information processing system 1000.

The feature construction unit 130 applies a function stored in advance in the function storage unit 110 or a function defined by the function definition unit 120 to a feature included in the data set. Accordingly, the feature construction unit 130 constructs a new feature that is a result obtained by applying the function to the feature.

The test unit 140 acquires, from, for example, the operator, a designation of a type of the analysis engine and a designation of the constraint condition.

In the first exemplary embodiment, the test unit 140 acquires “single regression analysis” as the type of the analysis engine. The test unit 140 acquires a designation of, among a plurality of features included in the data set, a feature that is an objective variable to be predicted by a function.

The test unit 140 inputs, as an explanatory variable, the new feature constructed by the feature construction unit 130 to a single regression analysis engine (not illustrated). The test unit 140 acquires a regression equation output by the single regression analysis engine. The test unit 140 tests whether the regression equation satisfies the constraint condition.

The output unit 150 outputs, for example, a regression equation that satisfies the requirement.

Hereinafter, with reference to FIG. 1 to FIG. 8, details of the function storage unit 110, the function definition unit 120, the feature construction unit 130, the test unit 140, and the output unit 150 will be described.

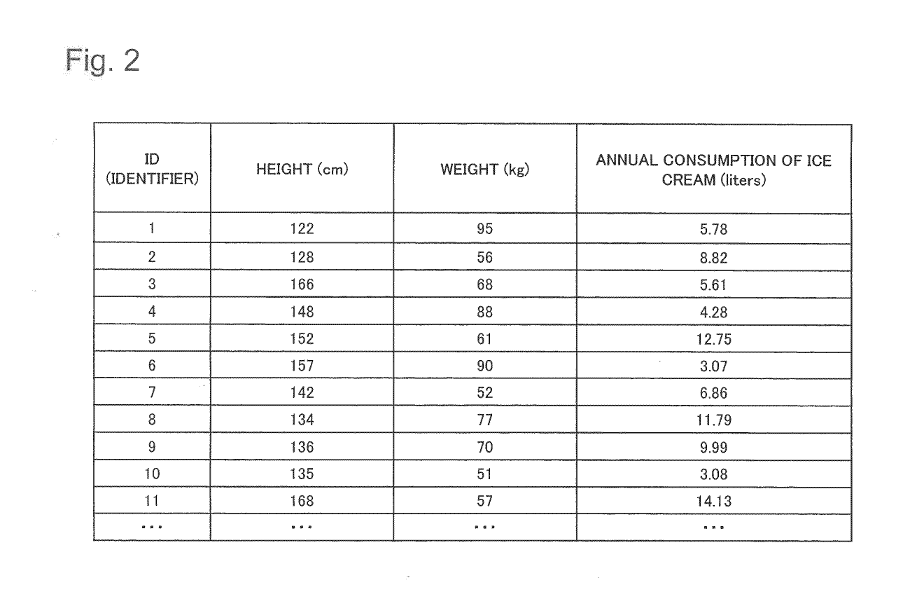

FIG. 2 is a diagram illustrating one example of a data set input to the information processing system 1000 illustrated in FIG. 1. As illustrated in FIG. 2, the data set includes information that correlates, for a plurality of persons, for example, an ID (identifier), a value of height, a value of weight, and an annual consumption of ice cream with one another. Each of “height,” “weight,” and “annual consumption of ice cream” illustrated in FIG. 2 is equivalent to the “feature.”

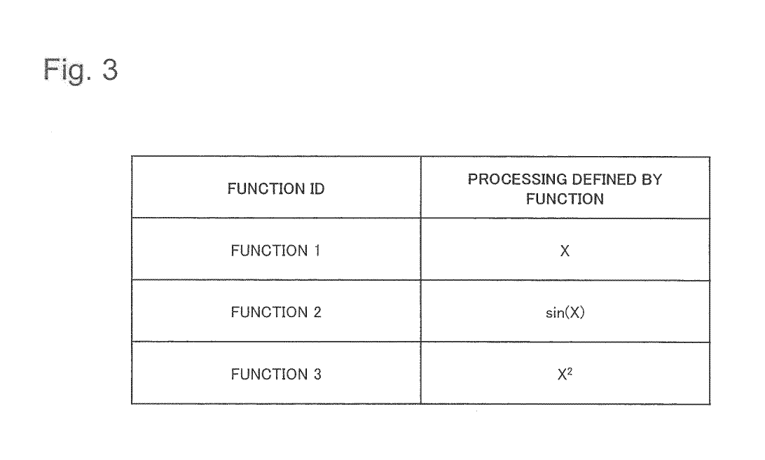

FIG. 3 is a diagram illustrating one example of information stored in the function storage unit 110 illustrated in FIG. 1. As illustrated in FIG. 3, a plurality of functions are stored in the function storage unit 110.

As illustrated in FIG. 3, processing defined by a function the function ID (identifier) of which is “function 1” is X. Here, X represents identity mapping. Processing defined by a function the function ID of which is “function 2” is sin(X). Here, sin represents a sine function. Processing defined by a function the function ID of which is “function 3” is X². Here, X² represents a function of squaring a value of X. In the following description, a function is indicated by a function ID of the function. For example, the function 2 indicates a function the function ID of which is the function 2.

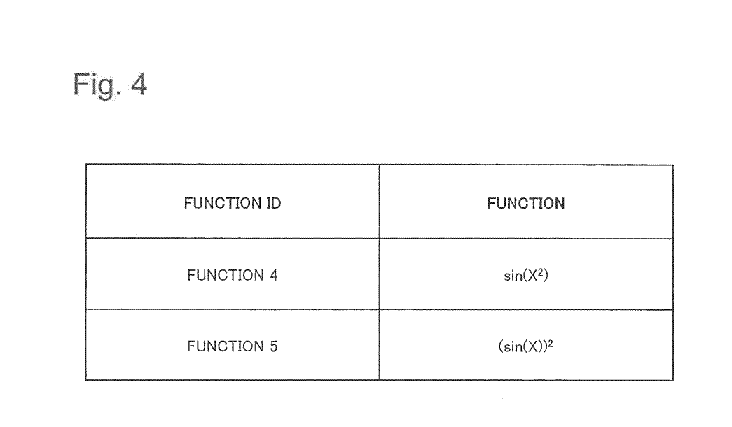

With reference to FIG. 1 and FIG. 4, details of the function definition unit 120 illustrated in FIG. 1 are described. FIG. 4 is a diagram illustrating new functions 4 and 5 output when the function definition unit 120 acquires the functions 1 and 3 illustrated in FIG. 3.

As illustrated in FIG. 4, the function definition unit 120 acquires the functions 1 to 3, and constructs the new functions 4 and 5.

The function definition unit 120 defines the new function 4 by composing, for example, the function 2 and the function 3. As illustrated in FIG. 4, processing defined by the function 4 is (sin(X²)). The function definition unit 120 may change an order for composing functions. The function definition unit 120 may define the function 5 by composing, for example, the function 2 and the function 3. As illustrated in FIG. 4, processing defined by the function 5 is (sin(X))².

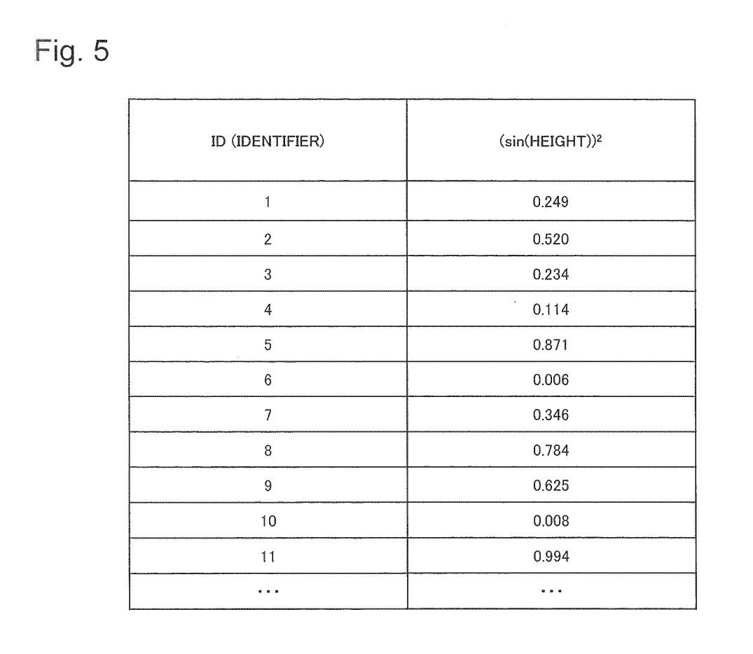

With reference to FIG. 1 and FIG. 5, details of the feature construction unit 130 illustrated in FIG. 1 are described below. As illustrated in FIG. 1, the feature construction unit 130 acquires a data set as a target. The feature construction unit 130 may acquire a designation of a feature that is an objective variable.

Suppose that, for example, the feature construction unit 130 acquires a designation of a feature that is “annual consumption of ice cream” as a feature that is an objective variable. Further suppose that the feature construction unit 130 acquires the function 5 (i.e. (sin(X))²) from the function storage unit 110. The feature construction unit 130 selects one feature to be input to the function from features (i.e. “height” and “weight”) other than the feature designated as the objective variable, among a plurality of features included in the data set.

Suppose that the feature construction unit 130 selects, for example, a value that is “height.” The feature construction unit 130 applies the selected function (sin(X))² to the selected feature “height” and constructs a new feature. A new feature constructed as the result is illustrated in FIG. 5.

FIG. 5 is a diagram illustrating a new feature constructed by the feature construction unit 130 applying the function (sin(X))² to the feature “height”.

Assuming that, for example, n features are received and m functions are received, the feature construction unit 130 constructs n times m new features.

Assuming that the feature construction unit 130 receives two features that are “height” and “weight”, and receives five functions from the function 1 to the function 5, the feature construction unit 130 constructs 2 times 5=10 new features. In other words, the feature construction unit 130 constructs ten new features listed below.
height,
   (height)²,
sin(height),
sin(height²),
   (sin(height))²,
weight,
   (weight),
sin(weight),
sin(weight²), and
(sin(weight))².

However, the feature construction unit 130 does not have to construct all of the ten new features described above. The feature construction unit 130 outputs the constructed features.

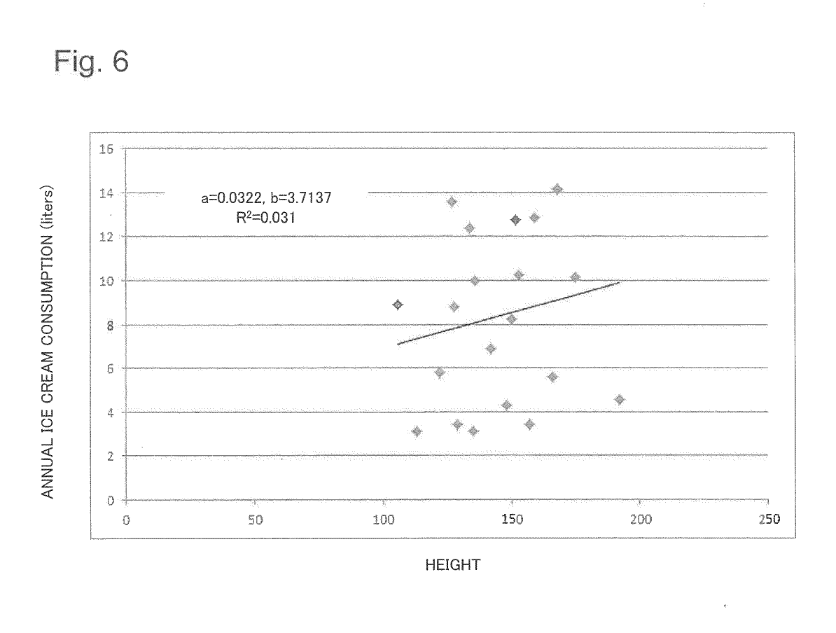

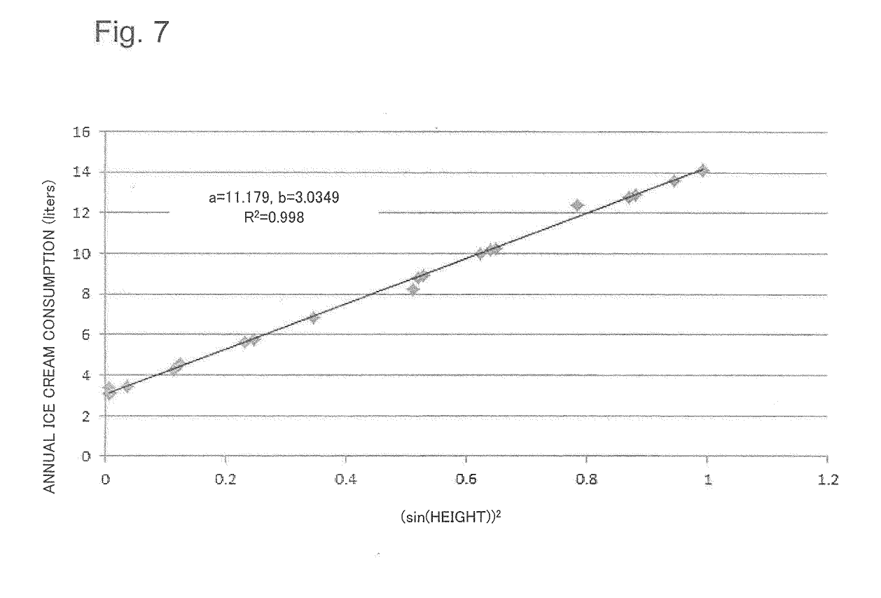

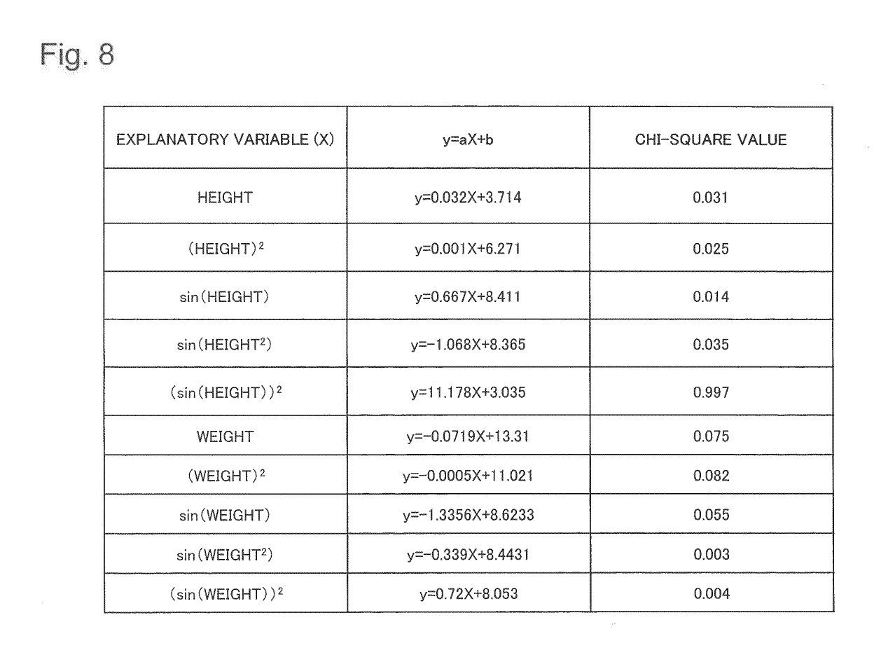

Details of the test unit 140 illustrated in FIG. 1 are described below with reference to FIG. 1, FIG. 6, FIG. 7, and FIG. 8. The following description is merely one specific example of an operation of the test unit 140, and the operation of the test unit 140 is not interpreted restrictively.

Suppose that the test unit 140 acquires “single regression analysis” as a type of the analysis engine, acquires “annual consumption of ice cream” as a feature that is an objective variable, and acquires a condition that is “a chi-square value is equal to or greater than 0.9” as a constraint condition.

In other words, the test unit 140 executes regression analysis according to an equation that is Y (annual consumption of ice cream)=aX+b. Here, Y is an objective variable. X is an explanatory variable. Symbols a and b are constants.

The test unit 140 analyzes an extent how well a feature (explanatory variable) constructed by the feature construction unit 130 can explain the annual consumption of ice cream (objective variable).

The test unit 140 acquires a feature included in a data set acquired by the feature construction unit 130. The test unit 140 acquires a feature output by the feature construction unit 130.

The test unit 140 selects one feature from a plurality of acquired features. Suppose that, for example, the test unit 140 selects a feature that is “height.”

FIG. 6 is a graph illustrating a result obtained by the test unit 140 selecting a feature that is “height” as an explanatory variable and executing single regression analysis on the basis of the explanatory variable. As illustrated in FIG. 6, as the result of the single regression analysis, a result that is a=0.0322 and b=3.7137 is obtained, and a chi-square value is 0.031.

FIG. 7 is a graph illustrating a result obtained by the test unit 140 selecting a feature that is “(sin(height))²” as an explanatory variable and executing single regression analysis on the basis of the explanatory variable. As illustrated in FIG. 7, as the result of the single regression analysis, a result that is a=11.179 and b=3.0349 is obtained, and a chi-square value is 0.998.

The test unit 140 executes, for each acquired feature, processing of inputting a feature to an analysis engine (in the example described above, a single regression analysis engine), processing of acquiring an analysis result (i.e. a regression equation and a chi-square value) output by the analysis engine, and processing of testing whether the analysis result (i.e. the chi-square value) satisfies the constraint condition.

FIG. 8 is a diagram illustrating a result obtained by the test unit 140 executing processing individually for ten types of features constructed by the feature construction unit 130. As illustrated in FIG. 8, an explanatory variable satisfying the constraint condition, that is “a chi-square value is equal to or greater than 0.9,” is “(sin (height))” only.

The fact that a chi-square value satisfies the constraint condition when “(sin (height))” is selected as the explanatory variable means, in other words, that it is possible to explain an individual annual consumption of ice cream according to a relational equation that is Y=aX+b by using a value derived by squaring a value obtained by substituting a value of height into a sine function (sin).

In contrast, as illustrated in other examples of FIG. 8, when another feature is selected as the explanatory variable, the chi-square value does not satisfy a testing threshold. This means that it is not possible to explain an individual annual consumption of ice cream on the basis of a value of the another feature when being along the relational equation that is Y=aX+b.

The output unit 150 outputs, for example, a regression equation satisfying the requirement.

The output unit 150 may operate as described below. Suppose that, for example, the constraint condition is satisfied by an analysis result obtained by an analysis engine to which, for example, a feature A described below:

feature A is: a value derived by squaring a value obtained by substituting a value of a feature B into a sine function (sin).

In this case, the output unit 150 may output information that “preprocessing should be executed to substitute a value of a feature that is height into a sine function (sin) and to further square an obtained value.” Alternatively, the output unit 150 may output information that “an analysis result satisfying the constraint condition can be obtained by inputting, to a designated analysis engine, a value derived by squaring a value obtained by substituting a value of a feature that is height into a sine function (sin).” Alternatively, the output unit 150 may output information that is “a value derived by squaring a value obtained by substituting a value of a feature that is height into a sine function (sin).” The output unit 150 may output such information together with a type of a designated analysis engine and a file name of a data set.

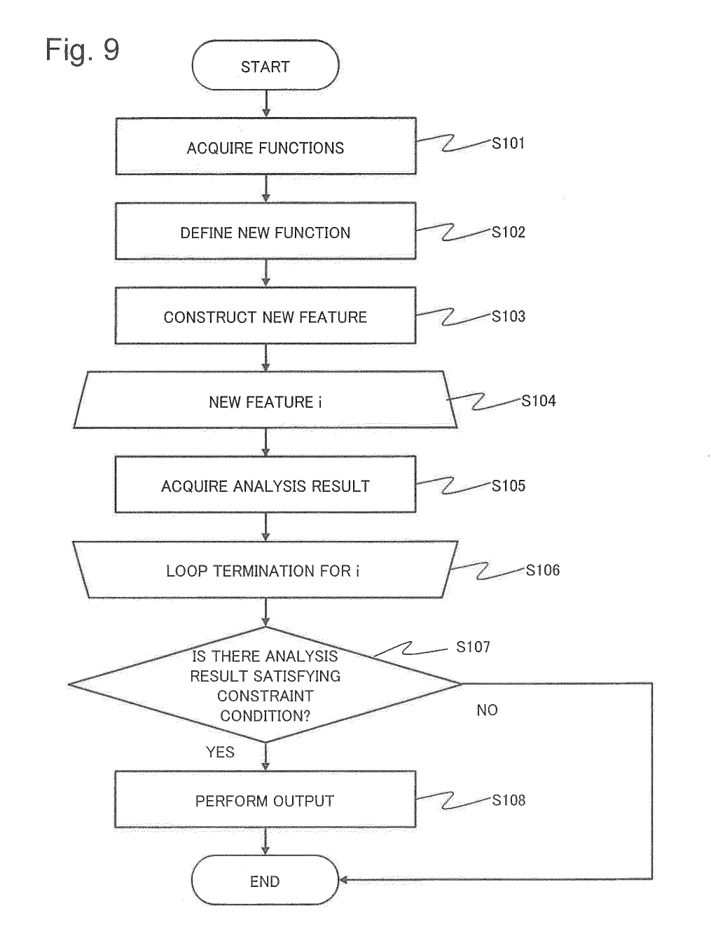

Next, an operation of the information processing system 1000 according to the first exemplary embodiment is described below. FIG. 9 is a flowchart illustrating the operation of the information processing system 1000 according to the first exemplary embodiment.

The function definition unit 120 acquires functions from the function storage unit 110 (Step S101). The function definition unit 120 defines a new function by composing the acquired existing functions (Step S102). The feature construction unit 130 inputs a feature to the new function, and calculates a value output in accordance with the function as a new feature. The feature construction unit 130 constructs a new feature for, for example, all combinations of the functions and the features (Step S103). The operation shown in Step S103 may be expressed in different words: inputting an acquired feature to a function, and calculating a value output in accordance with the function as a new feature.

The test unit 140 selects, from a plurality of new features, a specific feature (Step S104). The test unit 140 analyzes an extent how well a designated objective variable can be explained on the basis of the specific feature (explanatory variable). As a result, the test unit 140 obtains an analysis result (i.e. a regression equation and a chi-square value) (Step S105). The test unit 140 repeats the operation shown in Step S105 for all of the features constructed by the feature construction unit 130 (Step S106).

The test unit 140 tests whether an analysis result satisfying a constraint condition is obtained (Step S107). The operation shown in Step S107 may be executed during repetition from step S104 to step S106.

When an analysis result satisfying the constraint condition is obtained (YES in Step S107), the output unit 150 outputs the analysis result satisfying the constraint condition (Step S108). When an analysis result satisfying the constraint condition is not obtained (NO in Step S107), the output unit 150 does not output an analysis result satisfying the constraint condition.

An operation and an effect produced by the information processing system 1000 according to the first exemplary embodiment are described below. According to the first exemplary embodiment, it is possible to provide the information processing system 1000 that contributes to accuracy improvement in analysis processing.

The reason is that the feature construction unit 130 according to the first exemplary embodiment calculates a function for a feature, and constructs a new feature.

Owing to such a configuration, the information processing system 1000 is able to “increase the number of features that are candidates for an explanatory variable.” This may be rephrased as: it is possible to “increase the number of candidates for a feature for verifying a hypothesis.” Therefore, the present exemplary embodiment increases a possibility that an explanatory variable sufficiently explaining an objective variable is selected, and achieves an advantageous effect that accuracy of data mining is improved.

In the example described above, features input from an operator 900, i.e. features included in a data set are of three types (“height,” “weight,” and “annual consumption of ice cream”). In the example, one of the three types of features (i.e. “annual consumption of ice cream”) is designated as an objective variable. In this case, substantial candidates for an explanatory variable are two types of features (“height” and “weight”) other than the annual consumption of ice cream.

The information processing system 1000 constructs, as described above, ten new features on the basis of two types of features included in a data set that is a target and functions (the functions 1 to 3) stored in the function storage unit 110 or a function (the function 4 or 5) defined by the function definition unit 120.

Thus the information processing system 1000 can improve accuracy of data mining because of an increase of a possibility that a feature sufficiently explaining an objective variable is selected by increasing the number of features that are candidates for an explanatory variable.

The function definition unit 120 according to the first exemplary embodiment defines a new function by composing a plurality of functions.

Owing to such a configuration, the information processing system 1000 is able to construct a new feature by using a function other than a function prepared in advance. Accordingly, the feature construction unit 130 can construct more types of features.

The information processing system 1000 according to the first exemplary embodiment can output procedures of pre-processing that should be executed for a feature in order to improve accuracy of data mining. The reason is that, when obtaining an analysis result satisfying a constraint condition, the output unit 150 according to the first exemplary embodiment outputs a feature input to an analysis engine to obtain the analysis result. Alternatively, the reason is that the output unit 150 outputs information showing processing which should be executed for a feature included in a data set in order to obtain an analysis result satisfying a constraint condition.

The information processing system 1000 according to the first exemplary embodiment can reduce quantity of work of an analysis engineer who executes data analysis. The reason is that the feature construction unit 130 of the information processing system 1000 according to the first exemplary embodiment constructs a new feature on the basis of a plurality of features. And the test unit 140 of the information processing system 1000 selects, among constructed new features, a feature that meets a predetermined standard. In other words, the test unit 140 inputs, for example, a new feature which is constructed to an analysis engine that executes analysis processing on the basis of a feature which is input. And, the test unit 140 tests whether information output by the analysis engine satisfies a predetermined requirement. When, for example, the information which is output satisfies the predetermined requirement, the test unit 140 selects the feature that is input to the analysis engine. The predetermined requirement (i.e. constraint condition) means that, for example, a correlation with an objective variable is higher than a predetermined standard. In other words, when an analysis engineer inputs a plurality of features to the information processing system 1000, the information processing system 1000 can automatically or semi-automatically construct a feature highly correlated with the objective variable.

Specifically, according to, for example, the information processing system 1000 of the first exemplary embodiment, even when the analysis engineer does not know that there is a strong correlation between “individual annual consumption of ice cream” and “(sin(height))²,” the analysis engineer is able to obtain an analysis result with high accuracy. The reason is that on the basis of a feature that is “height,” the information processing system 1000 constructs a new feature that is “(sin(height))².” In other words, when the analysis engineer inputs a feature that is “height” to the information processing system 1000, the information processing system 1000 can construct a feature highly correlated with an objective variable, i.e. (sin(height))² automatically or semi-automatically for the user.

According to the information processing system 1000 of the first exemplary embodiment, an analysis engineer who executes data analysis can notice that there is a strong correlation between an objective variable and a feature which is newly constructed. For example, the analysis engineer who executes data analysis can notice that there is a strong correlation between “individual annual consumption of ice cream” and “(sin(height))².”

(Modification Examples of First Exemplary Embodiment)

The function definition unit 120 may read out an operator including a continuous value parameter n from the function storage unit 110 and substitute an optional value into n to define a new function. The operator including a continuous value parameter n is, for example, logₙ X or Xⁿ. When, for example, the function definition unit 120 reads out a function that defines logₙ X, the function definition unit 120 defines a new function such as log₂ X, log₃ X, log₅ X, or the like.

The test unit 140 may receive, for example, a designation of multiple regression analysis as a type of the analysis engine. Suppose that, for example, the test unit 140 receives a designation of multiple regression analysis (Z=aX+bY+c). Here, Z is an objective variable. X is a first explanatory variable. Y is a second explanatory variable. Symbols a, b, and c each are constants.

Suppose that the test unit 140 acquires, for example, ten features from the feature construction unit 130. In this case, the number of ways of selecting a combination of the first explanatory variable X and the second explanatory variable Y is 45 (=(10 times 9) divided by 2). The test unit 140 repeats the operations shown in Step S104 to Step S106 illustrated in FIG. 9 for 45 combinations of the explanatory variables.

The test unit 140 may receive curvilinear regression analysis as a type of the analysis engine. In this case, the test unit 140 receives a designation of a type of a curve such as an exponential function, a Gaussian function, or the like.

The modification examples described above are also applicable to other exemplary embodiments.

### Second Exemplary Embodiment

A second exemplary embodiment is one specific example of the present invention in a case where discriminant analysis is designated as a type of the analysis engine.

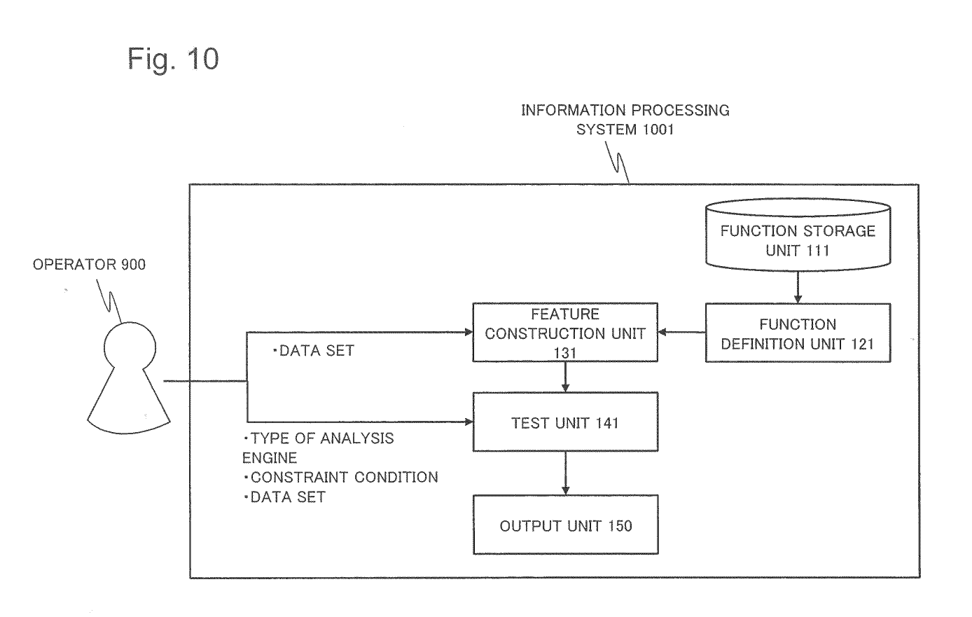

FIG. 10 is a block diagram illustrating a configuration of an information processing system 1001 according to the second exemplary embodiment. As illustrated in FIG. 10, the information processing system 1001 according to the second exemplary embodiment may have the following configuration.
Including a function storage unit 111 instead of the function storage unit 110 according to the first exemplary embodiment.
Including a function definition unit 121 instead of the function definition unit 120.
Including a feature construction unit 131 instead of the feature construction unit 130.
Including a test unit 141 instead of the test unit 140.

The first exemplary embodiment and the second exemplary embodiment are different in a data set to be handled and a type of the analysis engine to be designated.

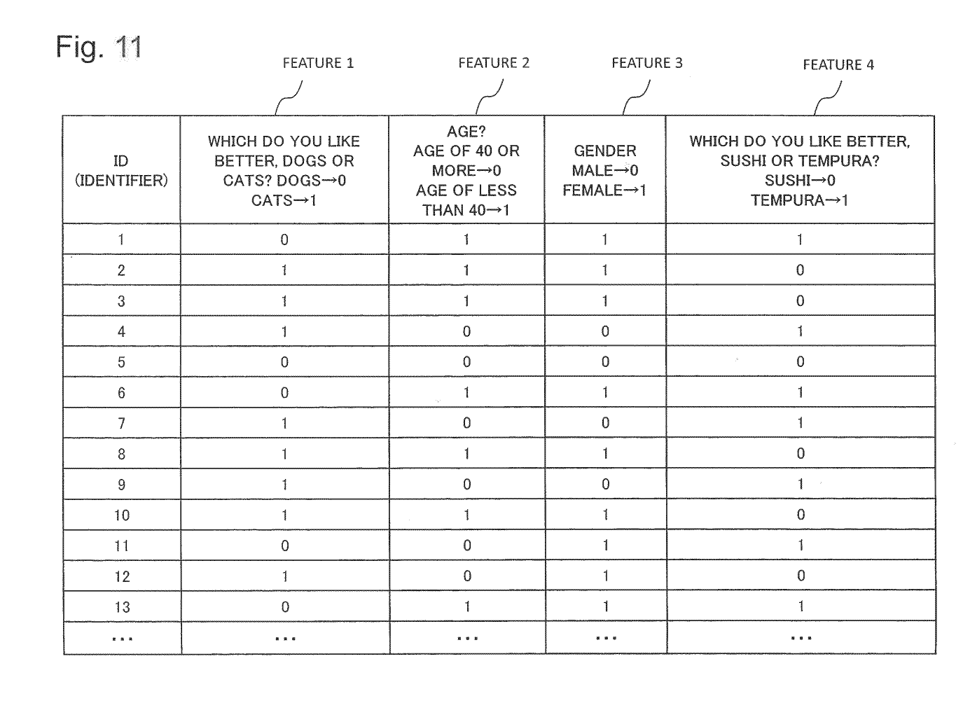

FIG. 11 is a diagram illustrating one example of a data set input to the information processing system 1001 illustrated in FIG. 10. The data set illustrated in FIG. 11 may be also referred to in another way as multivariable data. As illustrated in FIG. 11, the data set includes information that correlates a feature 1 to a feature 4 with each identifier for a plurality of persons. The data set illustrated in FIG. 11 is data representing, for example, answer results of a questionnaire for the plurality of persons. Each feature is an answer to a question item included in the questionnaire. The contents of the feature 1 to the feature 4 are listed below. Specifically, the question item and the value indicated by the answer are listed for each of the features.

Feature 1: Which do you like better, dogs or cats? (Dogs are indicated by 0 and cats are indicated by 1),

Feature 2: Age? (An age of 40 or more is indicated by 0 and an age of less than 40 is indicated by 1),

Feature 3: Gender? (A male is indicated by 0 and a female is indicated by 1), and

Feature 4: Which do you like better, sushi or tempura? (Sushi is indicated by 0 and tempura is indicated by 0).

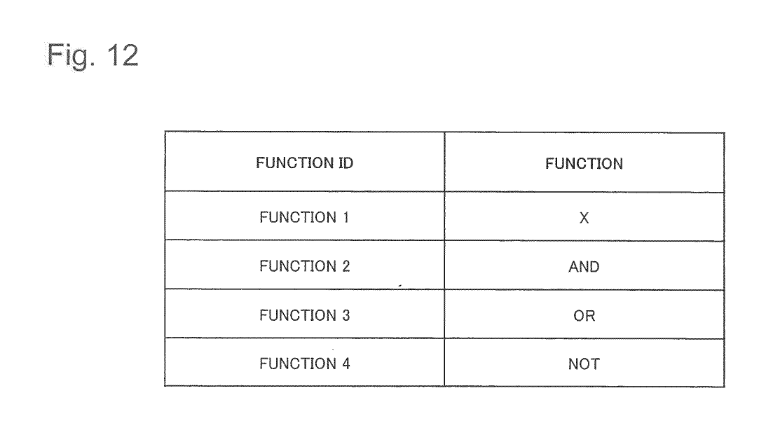

FIG. 12 is a diagram illustrating one example of information stored in the function storage unit 111 illustrated in FIG. 10. As illustrated in FIG. 12, the function storage unit 111 stores the functions 1 to 4. The function 1 defines identity mapping X. The function 2 defines a logical product (AND) operation of values of two features. The function 3 defines a logical sum (OR) operation of values of two features. The function 4 defines a negation (NOT) of a value of a feature.

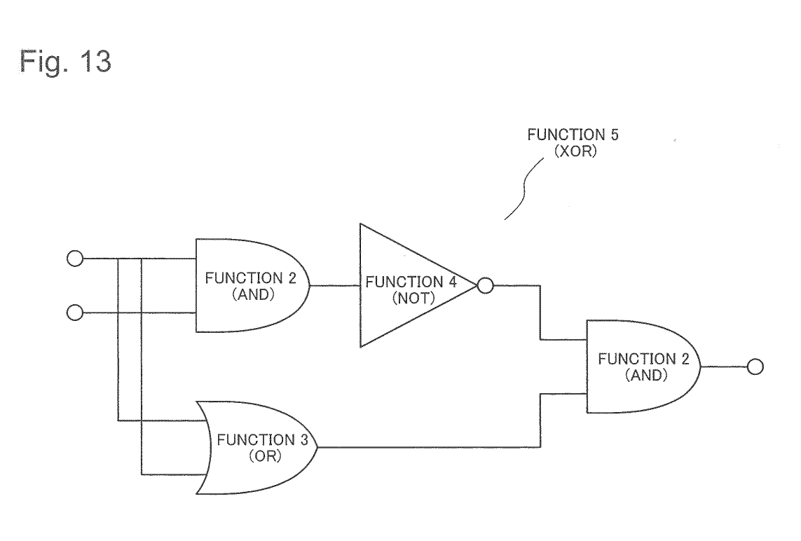

Details of the function definition unit 121 illustrated in FIG. 10 are described below with reference to an example illustrated in FIG. 13. FIG. 13 is a diagram illustrating a function 5 newly defined by the function definition unit 121 combining the functions 1 to 4. The function 5 defines exclusive OR (XOR).

As illustrated in FIG. 13, the function definition unit 121 defines a new function by combining the functions 1 to 4. Various variations are conceivable in a manner of combining the functions 1 to 4. One example illustrated in FIG. 13 is one variation of the manner of combining. FIG. 13 is a diagram illustrating the function 5 (XOR) defined by combining the function 2 (AND), the function 3 (OR), and the function 4 (NOT). The function definition unit 121 may combine the functions 1 to 4 and define a new function such as negative AND (NAND) or negative OR (NOR).

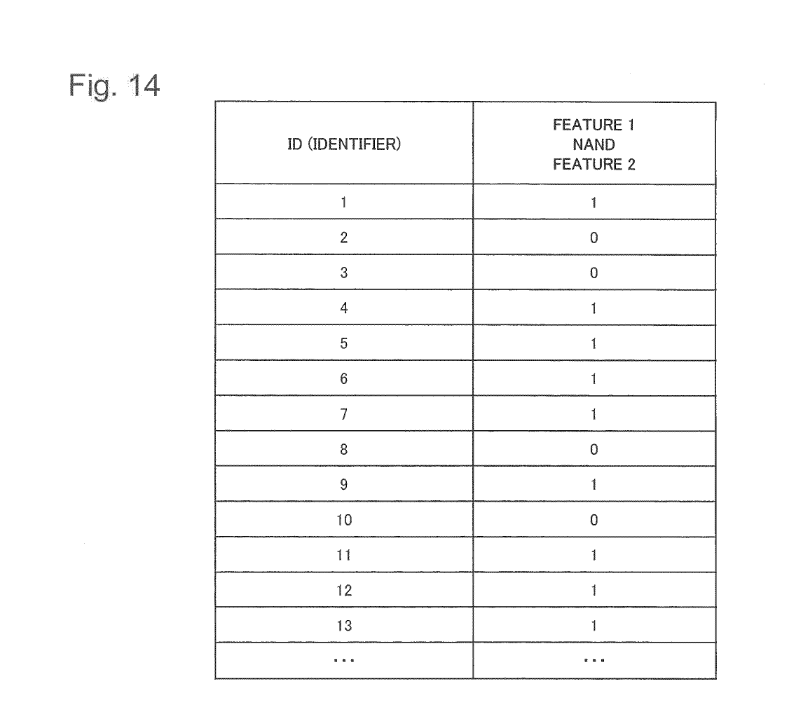

Details of the feature construction unit 131 illustrated in FIG. 10 are described below with reference to an example illustrated in FIG. 14. FIG. 14 is a diagram illustrating one specific example for a new feature constructed by the feature construction unit 131.

The feature construction unit 131 selects one function from a plurality of new functions defined by the function definition unit 121. The feature construction unit 131 selects one feature or a combination of features from a plurality of features included in a data set which is input. Suppose that, for example, the feature construction unit 131 selects “NAND” as a function, and selects the feature 1 and the feature 2 as features. New features constructed by the feature construction unit 131 as the result are listed in FIG. 14.

The feature construction unit 131 constructs new features, for example, for all of the new functions defined by the function definition unit 121. The feature construction unit 131 does not have to construct new features for all of the new functions.

Return to the description referring to FIG. 10. Here, suppose that “discriminant analysis” is designated as a type of the analysis engine for the test unit 141. Further suppose that the feature 4 (i.e. “which of sushi and tempura is preferred”) is designated as an objective variable for the test unit 141.

Suppose that the test unit 141 acquires a condition that is “a concordance rate is equal to or greater than 95%” as a constraint condition (i.e. a requirement that should be satisfied by information output by the analysis engine). The “concordance rate” is an index indicating a degree of concordance between values of a selected feature and values of a feature designated as a prediction target.

The test unit 141 analyzes whether “which of sushi and tempura is preferred” can be sufficiently explained on the basis of the new features constructed by the feature construction unit 131.

Details of the test unit 141 are described below. The test unit 141 acquires new features constructed by the feature construction unit 131. The test unit 141 selects one feature from a plurality of features which are acquired. Suppose that, for example, the test unit 141 selects a feature that is the “feature 3.”

The test unit 141 calculates a concordance rate between values of the selected feature and values of a feature designated as a prediction target.

Referring to FIG. 11, in the data for 13 persons illustrated, a value of the feature 3 is in concordance with a value of the feature 4 for data of five persons. Therefore, in the data for the 13 persons illustrated, a concordance rate between values of the feature 3 and values of the feature 4 is 0.38 (=5/13). The number of persons whose data is used to calculate the concordance rate may be designated, for example, in advance.

The test unit 141 calculates the concordance rate with values of the objective variable “which of sushi and tempura is preferred” for all of the features that are acquired.

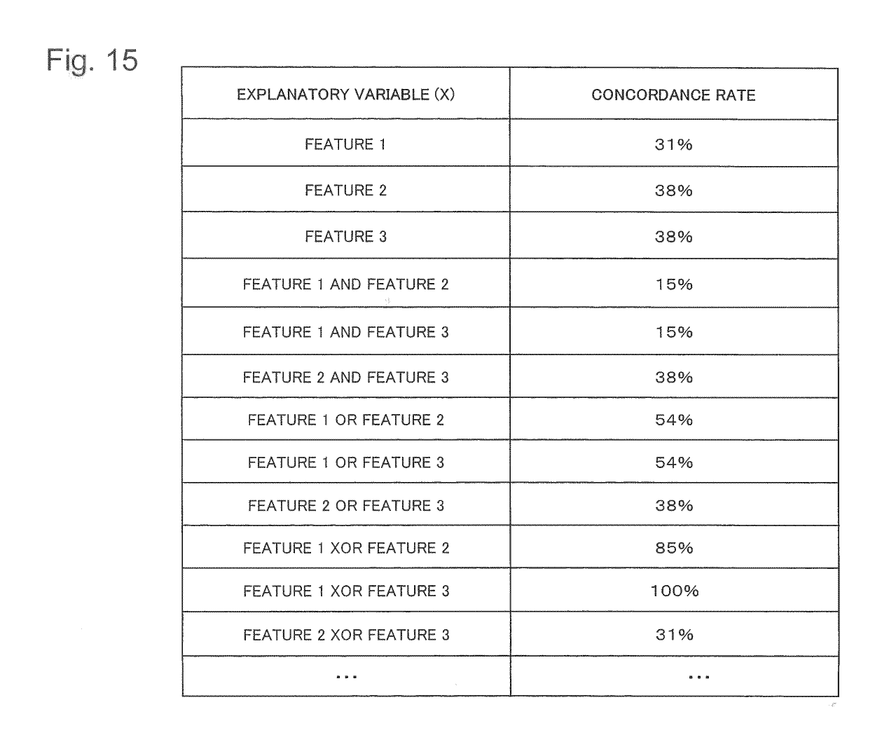

FIG. 15 is a diagram illustrating results of processing executed by the test unit 141 for the features constructed by the feature construction unit 131. As illustrated in FIG. 15, a concordance rate between values obtained by applying exclusive OR (XOR) to the feature 1 and the feature 3 and values of the feature 4 is 100%, which satisfies the constraint condition. In other words, this shows that the preference for “sushi” or “tempura” can be explained on the basis of the values of exclusive OR XOR of the “feature 1” and the “feature 3” in the questionnaire results.

An operation and an effect produced by the information processing system 1001 according to the second exemplary embodiment are described below. According to the second exemplary embodiment, it is possible to provide the information processing system 1001 that contributes to accuracy improvement in analysis processing.

The reason is that the feature construction unit 131 according to the second exemplary embodiment applies a function to a feature, and thereby constructs a new feature.

Owing to such a configuration, the information processing system 1001 can “increases the number of features that are candidates for an explanatory variable.” This may be rephrased as: it is possible to “increase the number of candidates for a feature to verify a hypothesis.” The present exemplary embodiment increases a possibility that an explanatory variable sufficiently explaining an objective variable is selected, and achieves an advantageous effect that accuracy of data mining is improved.

The function definition unit 121 according to the second exemplary embodiment defines a new function by composing a plurality of functions.

Owing to such a configuration, the information processing system 1001 constructs a new feature by using a function other than a function prepared in advance. This enables the feature construction unit 131 to construct a larger number of types of features.

The information processing system 1001 according to the second exemplary embodiment can output procedures of pre-processing that should be executed for a feature in order to improve accuracy of data mining. The reason is that, when obtaining an analysis result satisfying a constraint condition, the output unit 150 according to the second exemplary embodiment outputs a feature input to an analysis engine to obtain the analysis result. Alternatively, the reason is that the output unit 150 outputs information showing processing which should be executed for a feature included in a data set in order to obtain an analysis result satisfying a constraint condition.

### Third Exemplary Embodiment

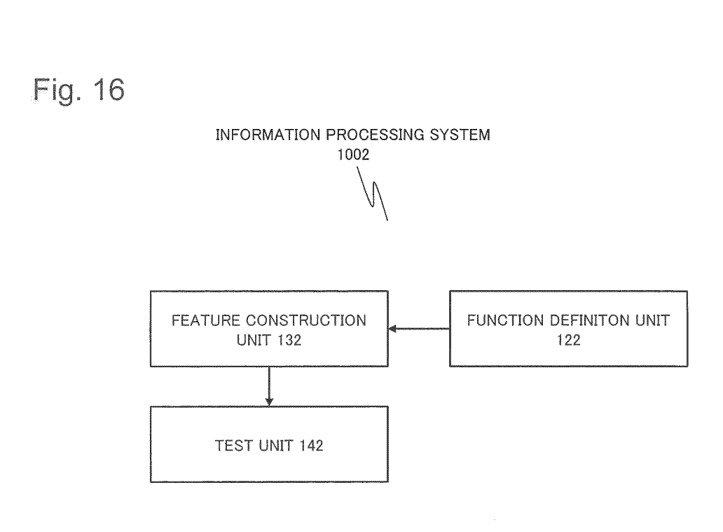

FIG. 16 is a block diagram illustrating a configuration of an information processing system 1002 according to a third exemplary embodiment. As illustrated in FIG. 16, the information processing system 1002 includes a function definition unit 122, a feature construction unit 132, and a test unit 142.

The function definition unit 122 defines a new function by composing a plurality of functions.

The feature construction unit 132 applies the new function to a feature, and defines a new feature that is a result obtained by applying the function to the feature.

The test unit 142 receives a selection of an analysis engine, receives an input of a requirement satisfied by information output by the analysis engine, inputs the new feature to the analysis engine which is selected, acquires information output by the analysis engine, and tests whether the acquired information satisfies the requirement.

According to the third exemplary embodiment, it is possible to provide the information processing system 1002 that contributes to accuracy improvement in analysis processing.

### Hardware Configuration of Information Processing System

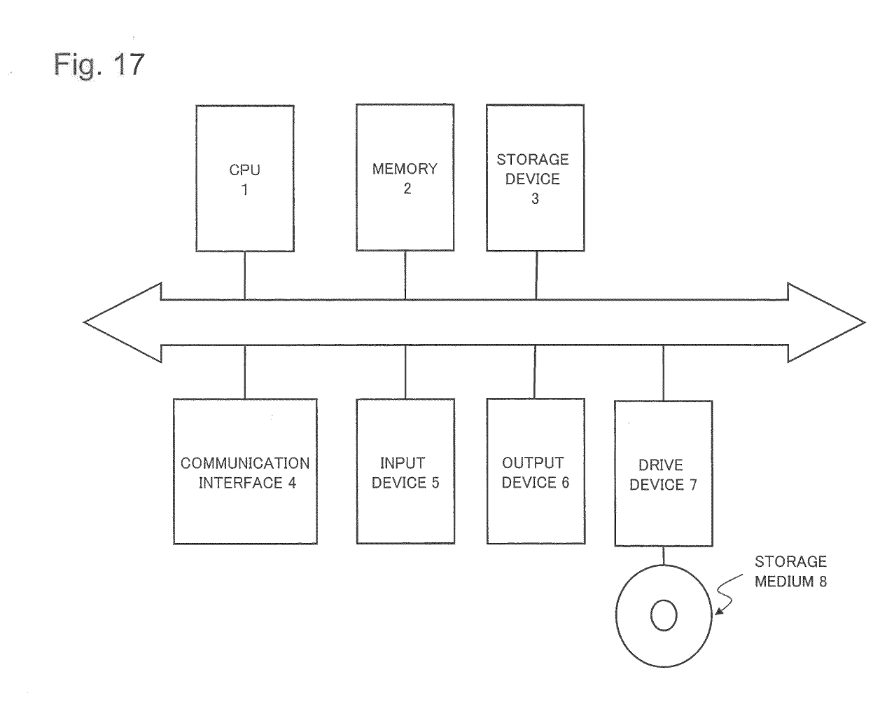

Hardware with which the information processing system (computer) 1000 illustrated in FIG. 17 is implemented includes a CPU (Central Processing Unit) 1, a memory 2, a storage device 3, and a communication interface (I/F) 4. The information processing system 1000 may include an input device 5 or an output device 6. A function of the information processing 100 is achieved, for example, by the CPU 1 executing a computer program (a software program, hereinafter, described simply as a “program”) loaded into the memory 2. In execution, the CPU 1 appropriately controls the communication interface 4, the input device 5, and the output device 6.

The present invention described using, as examples, the present exemplary embodiment and the exemplary embodiments described below may be achieved with a non-volatile storage medium 8 such as a compact disc storing the program. The program stored in the storage medium 8 is read out, for example, by a drive device 7.

Communication performed by the information processing system 1000 is achieved by an application program controlling the communication interface 4 by using, for example, a function provided by an OS (Operating System). The input device 5 is, for example, a keyboard, a mouse, or a touch panel. The output device 6 is, for example, a display. The information processing system 1000 may be achieved with two or more physically separated devices communicably connected with one another by cable, wireless, or a combination thereof.

The hardware configuration example illustrated in FIG. 17 is applicable to the exemplary embodiments described above. The information processing system 1000 may be a dedicated device. The hardware configurations of the information processing system 1000 and each function block thereof are not limited to the above configurations.

### Other Modification Examples

The analysis engine does not have to be implemented in the identical device that is the information processing system 1000. The analysis engine may only be accessible to the information processing system 1000. The above-described modification examples are applicable to other exemplary embodiments.

As described above, the present invention has been described by exemplifying cases where single regression analysis, multi-regression analysis, and discriminant analysis are designated as a type of the analysis engine.

The present invention is not limited to the exemplary embodiments described above and can be carried out in various modes. The present invention is also applicable to data mining using an analysis engine other than the types exemplified in the exemplary embodiments.

The exemplary embodiments described above can be carried out in appropriate combinations. The present invention is not limited to the exemplary embodiments described above and can be carried out in various modes.

The block division illustrated in each of the block diagrams is a configuration illustrated for convenience of explanation. The present invention described using each of the exemplary embodiments as an example is, regarding implementation thereof, not limited to the configuration illustrated in each of the block diagrams.

While exemplary embodiments to carry out the present invention have been described, the exemplary embodiments are intended for understanding the present invention easily, and are not intended for construing the present invention limitedly. It should be understood that the present invention can be modified and improved without departing from its spirit and the present invention includes equivalents thereof.

This application is based upon and claims the benefit of priority from U.S. patent application U.S. 61/883,660, filed on Sep. 27, 2013, the disclosure of which is incorporated herein in its entirety by reference.

### INDUSTRIAL APPLICABILITY

The present invention described using the above-described exemplary embodiments as examples can be used for, for example, a tool supporting data mining.

### REFERENCE SIGNS LIST

1 CPU
2 Memory
3 Storage device
4 Communication interface
5 Input device
6 Output device
7 Drive device
8 Storage medium
110 Function storage unit
111 Function storage unit
120 Function definition unit
121 Function definition unit
122 Function definition unit
130 Feature construction unit
131 Feature construction unit
132 Feature construction unit
140 Test unit
141 Test unit
142 Test unit
150 Output unit
900 Operator
1000 Information processing system
1001 Information processing system
1002 Information processing system

1. An information processing system comprising:
a memory storing a set of instructions; and
at least one processor configured to execute the set of instructions to:
define a new function by composing a plurality of functions;
construct, by applying the new function to a feature, a new feature that is a result obtained by applying a function to a feature; and
input the new feature to an analysis engine that executes analysis processing on a basis of the feature, and test whether information output by the analysis engine satisfies a predetermined requirement.

2. The information processing system according to claim 1, wherein
the at least one processor is configured to:
receive a selection of an analysis engine, receive an input of a requirement satisfied by information output by the analysis engine, and input the new feature to the analysis engine which is selected.

3. The information processing system according to claim 1, wherein
the at least one processor is configured to:
acquire a first function and a second function, and define a third function by composing the first function and the second function, and
processing defined by the third function is processing of sequentially executing, for the feature, processing defined by the first function and processing defined by the second function.

4. The information processing system according to claim 1, wherein
the at least one processor is configured to:
define a plurality of new functions,
construct, on a basis of individual new functions in the plurality of new functions, a plurality of new features, and
input a specific feature in the plurality of new features to the analysis engine, acquire information output by the analysis engine, and test whether the information output by the analysis engine satisfies a predetermined requirement.

5. The information processing system according to claim 4, wherein
the at least one processor is configured to:
execute, for each of the plurality of new features,
processing of inputting a specific feature in the plurality of new features to the analysis engine,
processing of acquiring the information output by the analysis engine, and
processing of testing whether the acquired information satisfies a predetermined requirement.

6. The information processing system according to claim 1, wherein
the at least one processor is configured to:
output a piece of information satisfying the requirement in pieces of information output by the analysis engine.

7. The information processing system according to claim 1, wherein
the at least one processor is configured to:
output, when the information output by the analysis engine satisfies the requirement, a feature input to the analysis engine to obtain the information output by the analysis engine, or a function applied in order to construct the feature and a feature to which the function is applied.

8. The information processing system according to claim 1, wherein
the at least one processor is configured to:
define the new function by composing a plurality of functions or mappings.

9. The information processing system according to claim 1, wherein
the at least one processor is configured to:
further receive a designation of any of the features as an objective variable and receive a number designation of explanatory variables as the requirement in a case where regression analysis is selected as an analysis engine.

10. A control method comprising:
controlling a computer accessible to a function storage unit storing a plurality of functions to:
define a new function by composing the plurality of functions;
construct, by applying the new function to a feature, a new feature that is a result obtained by applying a function to a feature;
input the new feature to an analysis engine that executes analysis processing on a basis of the feature; and
test whether information output by the analysis engine satisfies a predetermined requirement.

11. A non-transitory computer-readable recording medium storing a program that causes a computer accessible to a function storage unit storing a plurality of functions to execute:
processing of defining a new function by composing the plurality of functions;
processing of constructing, by applying the new function to a feature, a new feature that is a result obtained by applying a function to a feature; and
processing of inputting the new feature to an analysis engine that executes analysis processing on a basis of the feature, and testing whether information output by the analysis engine satisfies a predetermined requirement.

12. An information processing system comprising:
function definition means for defining a new function by composing a plurality of functions;
feature construction means for constructing, by applying the new function to a feature, a new feature that is a result obtained by applying a function to a feature; and
test means for inputting the new feature to an analysis engine that executes analysis processing on a basis of the feature, and testing whether information output by the analysis engine satisfies a predetermined requirement.
